(19) United States
(12) Patent Application Publication
(10) Pub. No.: US 2009/0156171 A1
(43) Pub. Date: Jun. 18, 2009

(54) SYSTEM AND METHOD OF PROCESSING MESSAGES

(75) Inventors: MEHRAD YASREBI, AUSTIN, TX (US); JAMES JACKSON, AUSTIN, TX (US)

Correspondence Address: AT&T Legal Department - AS;Attn: Patent Docketing, Room 2A-207, One AT&T Way, Bedminster, NJ, 07921, US

(73) Assignee: AT&T KNOWLEDGE VENTURES, L.P., RENO, NV (US)

(21) Appl. No.: 11/958,081

(22) Filed: Dec. 17, 2007

(51) Int. Cl. H04L 12/16; H04M 3/533; G06F 15/16; G06F 3/048; G10L 15/00

(52) U.S. Cl. 455/412.2; 709/206; 715/764; 455/413; 370/259; 704/275; 704/E15.001

(57) ABSTRACT

A system that incorporates teachings of the present disclosure may include, for example, a communication device having a controller to retrieve a communication identifier from a communication session, match an entry in an address book with the communication identifier, and store in one or more categories associated with the matched entry a message received by way of the communication session. Additional embodiments are disclosed.

### FIELD OF THE DISCLOSURE

The present disclosure relates generally to communication systems and more specifically to a system and method of processing messages.

### BACKGROUND

Numerous messaging devices today present messages such as emails, voicemail messages, and faxes in a single level or flat hierarchy. Some email applications such as Microsoft Outlook™ have attempted to improve the message presentation experience by providing a means for users to define rules to manage and organize the storage of email messages. Establishing these rules however requires a level of technical expertise that may be undesirable for some users.

### BRIEF DESCRIPTION OF THE DRAWINGS

FIGS. 1-2 depict exemplary embodiments of a communication system;

FIGS. 3-4 depict exemplary methods operating in portions of the communication system; and

FIG. 5 depicts an exemplary diagrammatic representation of a machine in the form of a computer system within which a set of instructions, when executed, may cause the machine to perform any plurality of the methodologies disclosed herein.

### DETAILED DESCRIPTION

In one embodiment of the present disclosure, a computer-readable storage medium can have computer instructions for recording in an address book a plurality of communication identifiers, associating at least a portion of the plurality of communication identifiers with one or more categories selected from a plurality of categories, detecting a communication session, retrieving from the communication session a communication identifier, comparing the communication identifier with entries in the address book, detecting a match between the communication identifier and an entry in the address book, identifying one or more categories associated with the matched entry, and storing in the identified one or more categories a message received by way of the communication session.

In one embodiment of the present disclosure, a communication device can have a controller to retrieve a communication identifier from a communication session, match an entry in an address book with the communication identifier, and store in one or more categories associated with the matched entry a message received by way of the communication session.

In one embodiment of the present disclosure, a method can involve retrieving a communication identifier from a communication session, identifying a match between the communication identifier and an entry in an address book, and storing in one or more categories associated with the matched entry a message received by way of the communication session.

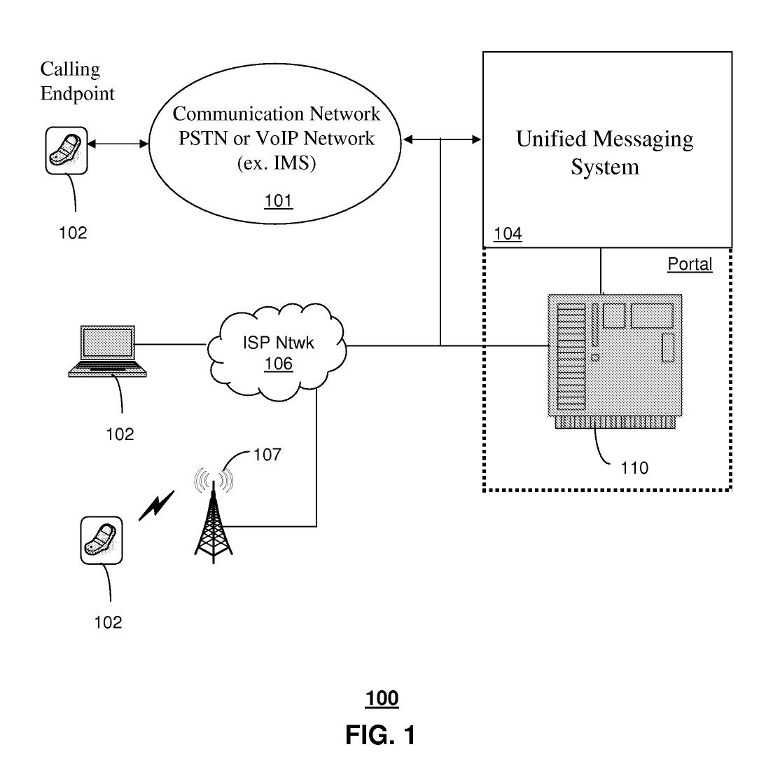

FIG. 1 depicts an exemplary embodiment of a communication system 100. Communication 100 comprises a calling end point 102 such as a cell phone, cordless phone, or wireline phone coupled to a communication network 101 such a Public Switched Telephone Network (PSTN), a Session Initiation Protocol (SIP)-based Voice over Internet Protocol (VoIP) network, or a hybrid network operating according to an IP Multimedia Subsystem (IMS) architecture. By way of the communication network 101, the calling end point 102 can interface with a unified messaging system (UMS) 104 to store, retrieve and process voicemail, email and fax messages—just to name a few.

The UMS 104 can interface to an Internet Service Provider (ISP) 106 to submit messages to fixed and mobile end points 102 over a wireline or wireless interface using for example a cellular network 107. In wireline applications, the messages can be submitted directly to a fixed end point 102 such as a computer capable of processing emails. In mobile applications, the UMS 104 can submit messages to mobile end points 102 such as cellular phones using a Short Message Service (SMS) or Multimedia Message Service (MMS) message format, or like over-the-air messaging services. The UMS 104 can further include a portal 110 that utilizes common web server technology to provide portal services to its subscribers over communication network 101, the ISP 106 and/or the cellular network 107.

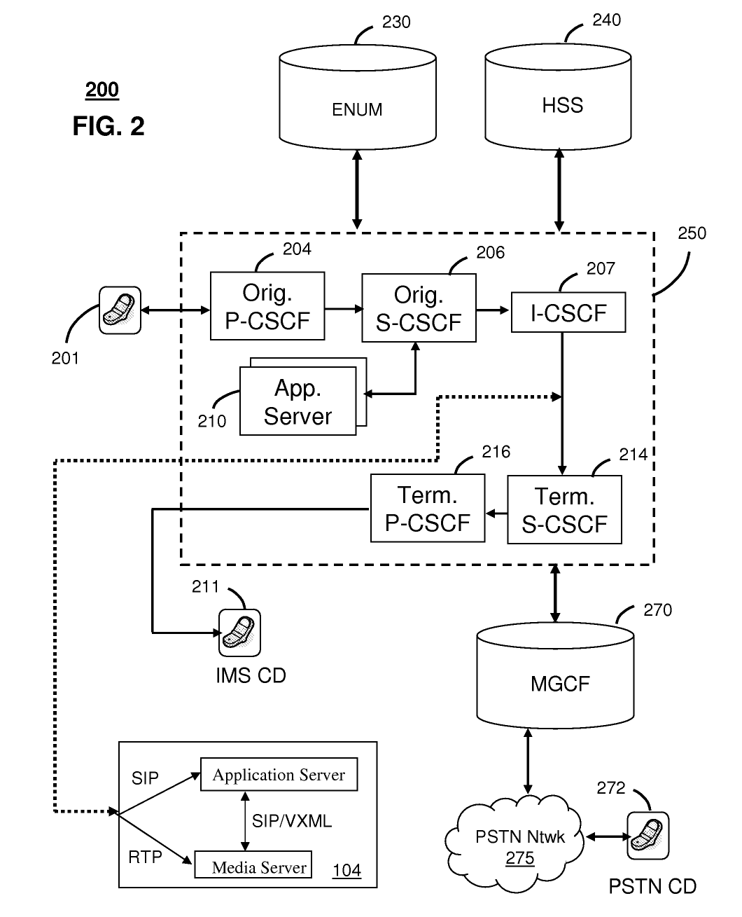

FIG. 2 depicts an exemplary embodiment of a communication system 200 employing an IMS network architecture. Communication system 200 can be overlaid or operably coupled with communication system 100 as another representative embodiment of communication system 100. The communication 200 can comprise a Home Subscriber Server (HSS) 240, a tElephone NUmber Mapping (ENUM) server 230, and common network elements of an IMS network 250. The IMS network 250 can be coupled to IMS communication devices such as an IMS-compliant phones 201, 211, and an IMS-compliant UMS 104 such as the one referred to earlier in FIG. 1. PSTN devices such as a PSTN phone 272 can be accessed by the IMS network 250 by way of a Media Gateway Control Function (MGCF) 270 coupled to a PSTN network 275.

The IMS communication devices 201, 211, and the PSTN phone 272 can be a representative embodiment of the calling end point 102 of FIG. 1, while the IMS network 250 can be a representative embodiment of the communication network 101 of FIG. 1.

To establish a communication session between phones, the IMS network 250 can utilize an originating Serving Call Session Control Function (S-CSCF) 206. The originating S-CSCF 206 can submit queries to the ENUM server 230 to translate an E.164 telephone number to a SIP Uniform Resource Identifier (URI) if the targeted communication device is IMS compliant. If the targeted communication device is a PSTN device such as reference 272, the ENUM server 230 will respond with an unsuccessful address resolution and the originating S-CSCF 206 will forward the call to the MGCF 270 which connects the call through the PSTN network 275 using a common signaling means such as SS7.

In the instance where the ENUM server 230 returns a SIP URI, the SIP URI is used by an Interrogating CSCF (I-CSCF) 207 to submit a query to the HSS 240 to identify a terminating S-CSCF 214 associated with a targeted IMS communication device such as IMS CD 211. Once identified, the I-CSCF 207 can submit the SIP INVITE message to the terminating S-CSCF 214 which then identifies a terminating P-CSCF 216 associated with the targeted communication device. The P-CSCF 216 can then signal the communication device to establish communications. When the targeted IMS communication device is the UMS 104, the ENUM system 230 can be programmed to supply a SIP URI to the originating S-CSCF 206 which then establishes communications between the originating communication device and the UMS.

The UMS 104 can include an application server 104 supporting SIP message processing, and a Voice eXtensible Markup Language (VXML) for interacting with a calling party by way of synthetic speech, and speech and Dual-Tone Multi-Frequency (DTMF) detection serving collectively the function of an Interactive Voice Response (IVR) system application. The UMS 104 can further include a media server that processes real-time packet streams conforming to a Real-time Transport Protocol (RTP), and interacts with the application server using SIP and VXML.

In addition to the aforementioned network elements of the IMS network 250, there can also be a number of application servers 210 which can provide a variety of communication services to IMS subscribers. For example, the application server 210 can be used to perform originating treatment functions on the calling party number received by the S-CSCF 206. Originating treatment functions can include determining whether the calling party number has international calling services, and/or is requesting special telephony features (e.g., *72 forward calls, *73 cancel call forwarding, etc.).

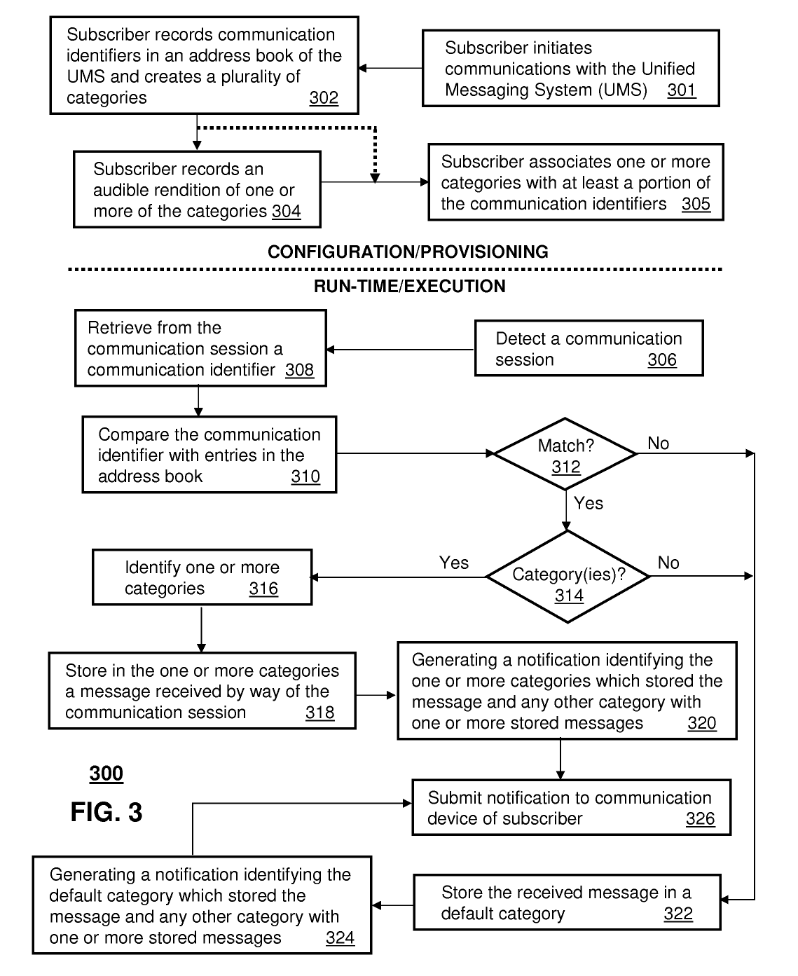

FIG. 3 depicts an exemplary method 300 operating in portions of the communication system 100. Method 300 can begin with step 302 where a subscriber initiates communications with the UMS 104. This step can represent a conventional packet or circuit-switched voice call over the communication network 101 with the UMS 104. In this embodiment, the UMS 104 utilizes the resources of the IVR application to interact with the subscriber. In another embodiment, step 301 can represent a subscriber establishing communications with the UMS 104 over the portal 110, which provides the subscriber a Graphical User Interface (GUI) to manage settings and/or messages stored by the UMS 104.

In step 302, the subscriber can record communication identifiers in an address book specifically tailored for the subscriber by the UMS 104. The address book can for example support a number of entries each identified by for example a party's name, job title, company name, business phone number, home phone number, mobile phone number, and email address. In step 302, the subscriber can define a plurality of categories which can be associated in step 305 with at least a portion of the communication identifiers stored in the address book. Prior to step 305, the subscriber can have the option to record an audible rendition of one or more of the categories defined in step 302. The audible renditions can be used by the UMS 104 to match speech commands of the subscriber to the audible renditions as will be described shortly.

Referring back to the creation of categories, the subscriber can create one or more categories to organize incoming messages supplied by calling parties. For example, the subscriber can create a category for family messages. To associate family messages with a family category, the subscriber can associate communication identifiers in the address book with the family category. For instance, the communication identifier 512-111-2222 recorded in an address book entry for Dad can be associated with a category “Messages from Dad”, while the communication identifier 512-111-2223 recorded in another address book entry can be associated with a category such as “Messages from Mom”. The same can be done for siblings, relatives (e.g., uncles, aunts, cousins, etc.), and so on.

A communication identifier in the present context can represent an identifying element of a communication device of a calling party. Communication identifiers can be represented by for example an email address, an E.164 number, a Session Initiation Protocol Uniform Resource Identifier (SIP URI), or an Instant Messaging (IM) address—just to mention a few. A category can be used to label inboxes for storing messages. For example, the inbox “ABC Company” can be used for storing voicemail, faxes, or email messages associated with employees of ABC company.

The category ABC Corporation can be associated with employees by using wild cards in the communication identifiers stored in the address book. For example, the number 512-33X-YYYY can be used to identify calls from ABC Corporation, where 33X represents an exchange ranging from 330 through 339, while the remaining four digits “YYYY” represents any phone number with the area code 512 and exchange 33X. The email address XXX@abc-corp.com can also be used as an identifying element for messages generated by ABC Corporation employees. In instances where the subscriber wants to treat certain employees uniquely, the subscriber can define category labels such as “Employees”, “Management” and “Staff” as sub-category labels for ABC Corporation. In this embodiment messages received by the UMS 104 from ABC corporation management and/or staff can be associated selectively with entries in the address book, while all other messages from ABC Corporation can default to the “Employees” category. With this organization structure, messages from ABC Corporation can be identified, organized and stored in a hierarchy defined by the subscriber (e.g., messages from known and configured management are stored in “Management”, messages from known and configured staff are stored in “Staff”, while all other messages are stored in “Employees”). It will be appreciated that sub-categories of ABC corporation can have their own independent category (i.e., not a sub-category of ABC corporation). For example “my boss” which could be a sub-category of ABC corporation can be defined as its own independent category. In this manner, the subscriber can manage messages of “my boss” independent of an ABC corporation hierarchy.

In step 305, the association between communication identifiers and categories can be accomplished many ways. In one embodiment, the UMS 104 can present the subscriber an overall GUI interface to manage the association of communication identifiers to categories with a drop-down menu next to each communication identifier. The drop-down menu can present the subscriber each of the available categories created by the subscriber to associate to the communication identifier in question. For each communication identifier, the association can take place by selecting by common means each of the categories of interest indicated for example by a checkmark or “X” mark located in a checkbox next to each selection. When selecting more than one category, the subscriber effectively creates a one-to-many association between the communication identifier and select categories. That is messages received from a calling party having a communication identifier that matches an entry in the address book with multiple categories associated therewith will be stored and/or referenced in these categories rather than a single category.

The drop-down menu can have a default setting which is presented at the time the communication identifier is first recorded in the address book. A default setting can represent a state in which no association is made between categories and the communication identifier being recorded. In this embodiment incoming messages can be stored in a default category by the UMS 104 when the message has a communication identifier that is not found in the address book. Similarly, the UMS 104 can store incoming messages in the default category when the message has a communication identifier that is found in the address book but has no association to a category (i.e., the communication identifier was recorded in the address book under a default setting). Thus, each time the subscriber adds a new entry in the address book, the subscriber has the option to associate communication identifier(s) with one or more corresponding categories defined by the subscriber or a default setting.

The above principles can be applied to categories defined by the subscriber for business clients, friends, family or other categories conceived by the subscriber. It should be noted that steps 301-305 can be performed as a background software process independently operated from steps 306-324 as indicated by the dashed line. That is, steps 301-305 represent configuration or provisioning steps taken by the subscriber, while steps 306-324 represent run-time execution/utilization steps.

With these concepts in mind, in step 306 the UMS 104 can be programmed to detect an incoming communication session initiated by a calling party that is targeting the subscriber of the UMS 104. The communication session can be a circuit-switched voice communication session, a packet-switched voice communication session, or a data communication session. In the case of a voice communication, the communication session can be a redirected VoIP or PSTN communication session processed by the UMS 104 when the subscriber does not respond to the call. Alternatively, the communication session can represent a data communication session established by a calling party to direct to the subscriber an email, fax, instant message, or SMS or MMS message.

Upon detecting the communication session, the UMS 104 can retrieve in step 308 by common means from the communication session a communication identifier associated with the session. The communication identifier can be a caller ID (e.g., E.164 number or SIP URI), an email address, or some other means of identifying the calling party or incoming message. In step 312, the UMS 104 can determine if the communication identifier matches an entry in the address book. If a match is not found, the UMS 104 can proceed to step 322 where it stores the message received from the communication session (e.g., voicemail, email, fax, etc) in a default category (as described earlier). In step 324, the UMS 104 can generate a notification identifying the default category which stored the incoming message and any other category with for example one or more unread messages.

For example, the notification might say, “You have received a message in your default inbox. You also have 10 unread messages in 4 other categories. To retrieve your messages contact your messaging service by selecting www.ums.com or directing a phone call to 512.444.5555.” A notification such as this can be transmitted to a communication device of the subscriber in step 326 as an email message with a subject heading with the above message, or by transmitting a paging message such as an SMS or MMS message including the notification and a selectable hyperlink which can be used to automatically call the UMS 104.

Referring back to step 312, if the communication identifier retrieved from the communication session matches an entry in the address book, the UMS 104 proceeds to step 314 where it determines if the communication identifier in the matched entry has an association with one or more categories. If it does not, the UMS 104 proceeds to steps 322-326 as previously described. Otherwise, the UMS 104 identifies the categories in step 316, and in step 318 stores the message and/or a reference to the message in the one or more categories. In step 320, the UMS 104 can then generate a notification that identifies the one or more categories which stored the received message and other categories having one or more unread stored messages.

For example, the notification might say, “You have received a new message in a category labeled Mom. You also have 6 unread messages in 3 other categories (Dad-3, Client A-2, ABC Corporation-1). If you desire to review these messages select the ‘Review Messages’ button provided in this notice.” The “Review Messages” button referred to in the notification can represent for example a GUI element operating as a selectable HTML hyperlink which can invoke a communication session between the communication device of the subscriber receiving the notification and the UMS 104. Step 326 transmits the notification to the communication device of the subscriber as previously described.

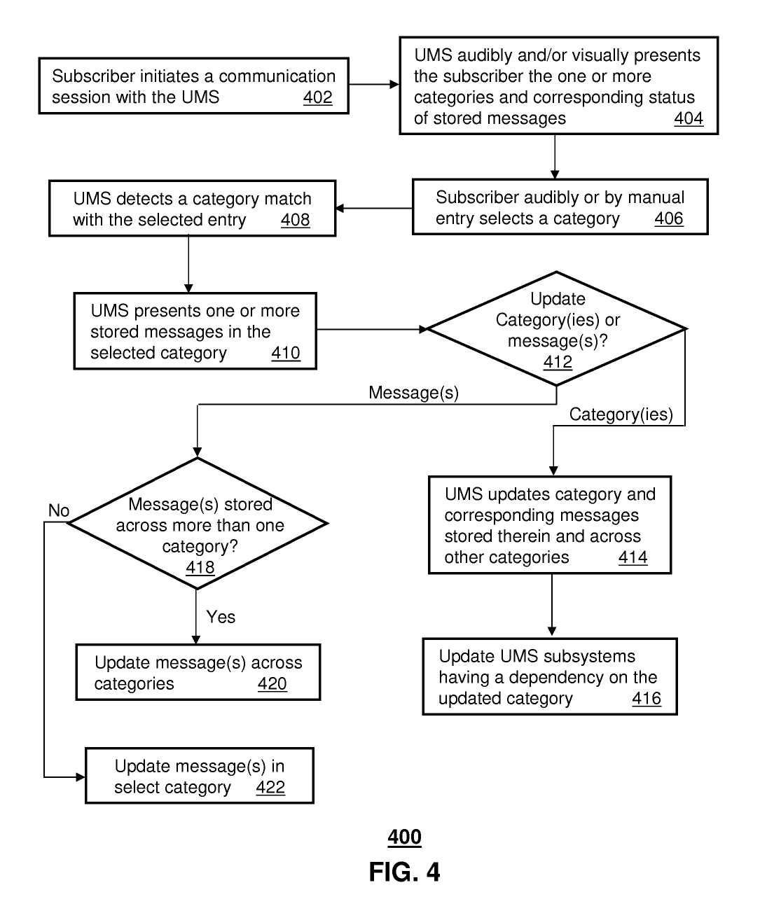

FIG. 4 depicts an exemplary method 400 for reviewing messages stored by the UMS 104 as described above for method 300. Method 400 begins with step 402 where the subscriber initiates a communication session with the UMS 104. This step can represent action taken by the subscriber to respond to the notification message received in step 326 (such as by selecting by common means the “Review Messages” GUI element included in the notification). The subscriber can contact the UMS 104 over a voice channel thereby invoking the IVR application, or by way of the portal 110 which presents a website GUI for processing messages stored by the UMS. In step 404, the UMS 104 can audibly present the subscriber the one or more categories and corresponding status of stored messages. Alternatively or in combination, the UMS 104 can visually present the status of stored messages in their respective categories such as shown below:

You have 20 unread messages and a total of 50 recorded messages. Select any of the following categories to review your unread messages.

1. Family (2)*

2. ABC Corporation (10)

3. Client A (3)

4. Client B (2)*

5. Default (3)

As noted earlier, categories may be hierarchical. For example, the category Family when selected might show: Dad (1), Mom (1), Siblings, Uncles, Aunts, etc. The asterisk next to the categories Family and Client B can also indicate to the subscriber that these categories can be audibly selected by the subscriber with speech commands. In step 406, the subscriber can audibly and/or manually using DTMF signals, or a GUI action such as a mouse button selection via the portal 110 select a category to review messages. In step 408, the UMS 104 can detect the category that matches the audible and/or manual entry. For example, the UMS 104 can match a speech command with the category Family and thereby navigate one level down the hierarchy to present the sub-categories Dad (1), Mom (1), Siblings, Uncles, Aunts, etc. The subcategories can be similarly selected by audible commands if the subscriber has provided an audible rendition of each category. Alternatively, the subscriber can select the category Family by depressing the 1 key on the keypad of a telephone, or selecting it with a mouse pointer when navigating a website of the portal 110.

In step 410, the UMS 104 can present the stored messages in the selected category. The presentation can be an audible presentation of a voicemail message, a text to speech presentation for text messages such as emails, and/or a visual presentation over a display screen of a communication device such as a cellular phone, fixed line telephone, or computer screen. Optionally the subscriber in step 412 can also update categories and/or messages stored therein. Updating a category can represent changing its name, moving it within a hierarchy, or deleting it, while updating messages can represent copying or moving messages to other inboxes or directory folders, or deleting them.

In the case of message updates, the UMS 104 can proceed to step 418 where it determines whether the intended message update is stored across more than one category. As noted earlier in step 305, messages can be stored in categories in a one-to-many format. Thus when a message deletion is requested, for example, the UMS 104 can proceed to step 420 to delete messages across multiple categories and/or query the subscriber whether s/he wants to delete the selected message across all categories in one step, or on a case-by-case basis. If the message to be updated is stored in a single category, the UMS 104 can proceed to step 422 where it performs the requested update without dependencies.

Referring back to step 412, the UMS 104 proceeds to step 414 when it detects a request by the user to update one or more categories. In this step, the UMS 104 can update the category and corresponding messages stored therein as well as duplicate copies of the messages in other categories. For example, if a select category is deleted, the UMS 104 can query the subscriber as to whether s/he desires to delete the messages in the category as well. If the subscriber desires to keep the messages, the UMS 104 can provide the subscriber the option to move the messages to a default category inbox. If the subscriber accepts deletion of the messages, the UMS 104 can determine whether the messages to be deleted are recorded in other categories. If it detects that there are duplicate copies, it can query the subscriber as to whether those messages should be deleted as well (similar to what was described for step 420). In the case where the category update is something other than a deletion (e.g., a renaming of the category), the messages stored in the updated category can remain unchanged.

To synchronize the change of the select category, the UMS 104 proceeds to step 416 where it updates UMS subsystems having a dependency on the affected category. For instance, a change in the name of the category can affect the address book subsystem of the UMS 104. Similarly, a name change can affect the IVR and the portal 110 applications of the UMS 104 in its presentation of messages to the subscriber. By synchronizing subsystems of the UMS 104, the UMS can provide the subscriber a holistic user-friendly experience without forcing the subscriber to address individually all the interdependencies affecting the recording, presentation and processing of messages by the UMS.

Upon reviewing the embodiments disclosed, it would be evident to an artisan with ordinary skill in the art that said embodiments can be modified, reduced, or enhanced without departing from the scope and spirit of the claims described below. For example, method 300 can be adapted so that speech commands of the subscriber can be matched to category labels without requiring a subscriber to provide an audible rendition of the category. To accomplish this embodiment, the IVR application of the UMS 104 can be adapted to use a common speaker-independent speech to text synthesizer to match speech commands to categories without voice training. In yet another embodiment, methods 300 and 400 can be integrated in whole or in part in a communication device of the subscriber (e.g., cellular phone, computer, personal digital assistant or PDA, etc.) having messaging capabilities similar to those of the UMS 104.

Other suitable modifications can be applied to the present disclosure without departing from the scope of the claims below. Accordingly, the reader is directed to the claims for a fuller understanding of the breadth and scope of the present disclosure.

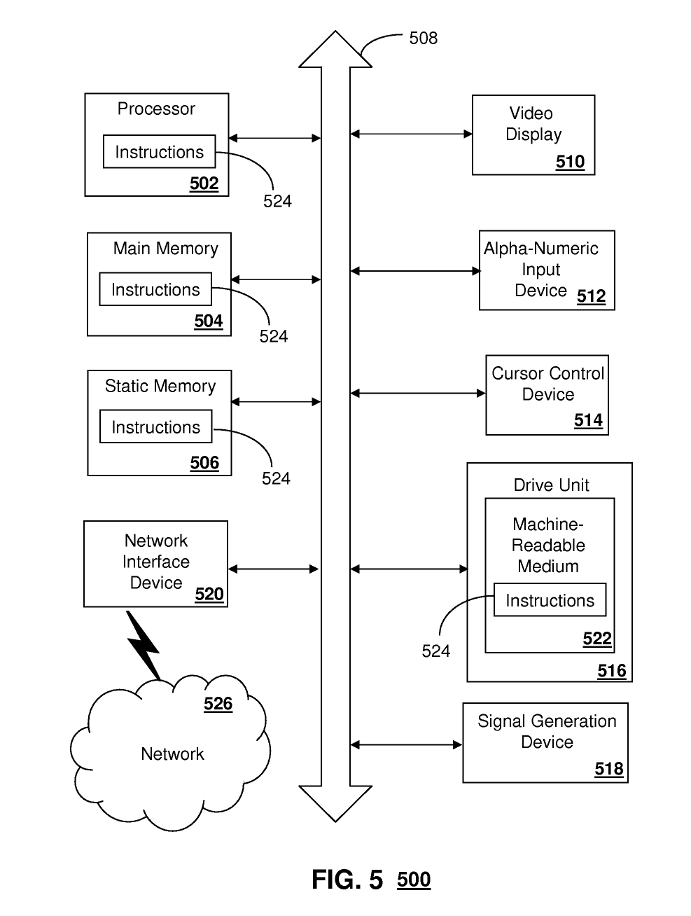

FIG. 5 depicts an exemplary diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated above. The instructions 524 may also reside, completely or at least partially, within the main memory 504, the static memory 506, and/or within the processor 502 during execution thereof by the computer system 500. The main memory 504 and the processor 502 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
recording in an address book a plurality of communication identifiers;
associating at least a portion of the plurality of communication identifiers with one or more categories selected from a plurality of categories, wherein each category is used for selectively storing messages;
detecting a communication session;
retrieving from the communication session a communication identifier;
comparing the communication identifier with entries in the address book;
detecting a match between the communication identifier and an entry in the address book;
identifying one or more categories associated with the matched entry; and
storing in the identified one or more categories a message received by way of the communication session.

2. The storage medium of claim 1, wherein the plurality of communication identifiers correspond to at least one among an E.164 number, a Session Initiation Protocol Uniform Resource Identifier (SIP URI), an instant messaging address, and an email address.

3. The storage medium of claim 1, wherein the received message corresponds to at least one among a voicemail message supplied by a calling party initiating the communication session, an email message, a Short Message Service (SMS) message, and Multimedia Message Service (MMS) message.

4. The storage medium of claim 1, wherein the communication session corresponds to one among a circuit-switched voice communication session, a packet-switched voice communication session, and a data communication session.

5. The storage medium of claim 4, wherein the packet-switched voice communication session corresponds to a Voice over IP (VoIP) communication session, and wherein the VoIP communication session originates from an IP Multimedia Subsystem (IMS) communication system.

6. The storage medium of claim 1, wherein the communication session is directed to a subscriber, and wherein the storage medium comprises computer instructions for:
generating responsive to the storing step a notification identifying the one or more categories which stored the received message and any other category of the plurality of categories having one or more stored messages; and
submitting the notification to the subscriber.

7. The storage medium of claim 6, comprising computer instructions for:
organizing the one or more categories identified in the notification; and
identifying a number of stored messages in each of the one or more categories.

8. The storage medium of claim 7, wherein the one or more categories are organized in at least one among an alphabetical order and a hierarchy.

9. The storage medium of claim 6, comprising computer instructions for conveying the notification to a communication device of the subscriber in at least one among an email, an SMS message, and an MMS message.

10. The storage medium of claim 1, comprising computer instructions for:
detecting a communication initiated by a subscriber;
audibly presenting the one or more categories;
receiving an audible selection from the subscriber;
detecting a match between the audible selection and one among the one or more categories;
presenting the subscriber the one or more messages stored in the matched category responsive to said detection.

11. The storage medium of claim 10, comprising computer instructions for:
applying an audible identification to at least one of the one or more categories; and
detecting a match between the audible selection and one among the one or more categories according to its corresponding audible identification.

12. The storage medium of claim 10, wherein the storage medium operates according to an Interactive Voice Response (IVR) system, and wherein the IVR system interacts with the subscriber using synthesized speech, voice recognition, and dual tone multi-frequency signals.

13. The storage medium of claim 10, comprising computer instructions for:
receiving a request from the subscriber to delete at least one of the one or more messages stored in the matched category;
detecting that the at least one message is stored also in one or more other categories; and
deleting the at least one message from the matched category and the one or more other categories.

14. The storage medium of claim 1, comprising computer instructions for:
receiving a request from the subscriber to update at least one of the plurality of categories; and
updating the at least one categories across one or more subsystems utilizing the at least one category.

15. The storage medium of claim 14, wherein the updating step corresponds to editing or removing the at least one category from the one or more subsystems, and wherein the one or more subsystems comprise at least one among the address book, a call tree used by an IVR system, and a storage system that stores messages for the at least one category.

16. The storage medium of claim 9, wherein the storage medium operates in a Unified Messaging System (UMS) that provides at least one among voicemail services, email services, and fax services, and wherein the notification includes a selectable link for automatically initiating a communication session between the communication device and the UMS.

17. A communication device, comprising a controller to:
retrieve a communication identifier from a communication session;
match an entry in an address book with the communication identifier; and
store in one or more categories associated with the matched entry a message received by way of the communication session.

18. The communication device of claim 17, wherein the controller is adapted to:
record in the address book a plurality of communication identifiers;
associate each of the plurality of communication identifiers with one or more categories selected from a plurality of categories, wherein each category is used for storing messages; and
identify the one or more categories used for storing the received message by comparing the communication identifier with entries in the address book.

19. The communication device of claim 17, wherein the communication identifier corresponds to at least one among an E.164 number, a Session Initiation Protocol Uniform Resource Identifier (SIP URI), and an email address, and wherein the received message corresponds to at least one among a voicemail message supplied by a calling party initiating the communication session, an email message, a Short Message Service (SMS) message, and Multimedia Message Service (MMS) message.

20. The communication device of claim 17, wherein the communication session corresponds to one among a circuit-switched voice communication session, a packet-switched voice communication session, and a data communication session, and wherein the packet-switched voice communication session corresponds to a Voice over IP (VoIP) communication session, and wherein the VoIP communication session originates from an IP Multimedia Subsystem (IMS) communication system.

21. The communication device of claim 18, wherein the controller is adapted to present in a Graphical User Interface (GUI) the one or more categories which stored the received message and any other category of the plurality of categories having one or more stored message.

22. The communication device of claim 21, wherein the controller is adapted to:
organize the one or more categories presented in the GUI according to at least one among an alphabetical order and a hierarchy; and
identify a number of stored messages in each of the one or more categories.

23. The communication device of claim 21, wherein the controller is adapted to:
audibly present the one or more categories;
receive an audible selection from the subscriber;
detect a match between the audible selection and one among the one or more categories;
present the subscriber the one or more messages stored in the matched category responsive to said detection.

24. A method, comprising:
retrieving a communication identifier from a communication session;
identifying a match between the communication identifier and an entry in an address book; and
storing in one or more categories associated with the matched entry a message received by way of the communication session.

25. The method of claim 24, comprising:
recording in the address book a plurality of communication identifiers;
associating each of the plurality of communication identifiers with one or more categories selected from a plurality of categories, wherein each category is used for storing messages; and
identifying the one or more categories used for storing the received message by comparing the communication identifier with entries in the address book.
